(19) United States
(12) Patent Application Publication
(10) Pub. No.: US 2013/0144414 A1
(43) Pub. Date: Jun. 6, 2013

(54) METHOD AND APPARATUS FOR DISCOVERING AND LABELING SPEAKERS IN A LARGE AND GROWING COLLECTION OF VIDEOS WITH MINIMAL USER EFFORT

(71) Applicants: Sachin Kajarekar, Sunnyvale, CA (US); Ananth Sankar, Palo Alto, CA (US); Sattish Gannu, San Jose, CA (US); Aparna Khare, Sunnyvale, CA (US)

(72) Inventors: Sachin Kajarekar, Sunnyvale, CA (US); Ananth Sankar, Palo Alto, CA (US); Sattish Gannu, San Jose, CA (US); Aparna Khare, Sunnyvale, CA (US)

(73) Assignee: Cisco Technology, Inc., San Jose, CA (US)

(21) Appl. No.: 13/312,800

(22) Filed: Dec. 6, 2011

(51) Int. Cl. G06F 17/00

(52) U.S. Cl. 700/94

(57) ABSTRACT

In one embodiment, an audio stream is partitioned into a plurality of segments such that the plurality of segments are clustered into one or more clusters, each of the one or more clusters identifying a subset of the plurality of segments in the audio stream and corresponding to one of a first set of one or more speaker models, each speaker model in the first set of speaker models representing one of a first set of hypothetical speakers. The speaker models in the first set of speaker models are compared with a second set of one or more speaker models, where each speaker model in the second set of speaker models represents one of a second set of hypothetical speakers. Labels associated with one or more speaker models in the second set of speaker models are propagated to one or more speaker models in the first set of speaker models according to a result of the comparing step.

### BACKGROUND

1. Technical Field

The present disclosure relates generally to a mechanism for labeling audio streams.

2. Description of the Related Art

Speaker segmentation has sometimes been referred to as speaker change detection. For a given audio stream, speaker segmentation systems find speaker change points (e.g., the times when there is a change of speaker) in the audio stream. A first class of speaker segmentation systems performs a single processing pass of the audio stream, from which the change-points are obtained. A second class of speaker segmentation systems performs multiple passes, refining the decision of change-point detection on successive iterations. This second class of systems includes two-pass algorithms where in a first pass many change-points are suggested and in a second pass such changes are reevaluated and some are discarded. Also part of the second class of systems are those that use an iterative processing of some sort to converge into an optimum speaker segmentation output.

Speaker clustering is often performed to group together speech segments of a particular audio stream on the basis of speaker characteristics. Speaker clustering may be accomplished through the application of various algorithms, including clustering techniques using Bayesian Information Criterion (BIC).

Systems that perform both segmentation of an audio stream into different speaker segments and a clustering of such segments into homogeneous groups are often referred to as “speaker diarization” systems. Thus, speaker diarization is a combination of speaker segmentation and speaker clustering. With the increasing number of broadcasts, meeting recordings, and voice mail collected every year, speaker diarization has received a great deal of attention in recent times.

### BRIEF DESCRIPTION OF THE DRAWINGS

FIG. 1 is a process flow diagram illustrating an example method of implementing a system for discovering and labeling speakers in accordance with various embodiments.

FIGS. 2A-2B are process flow diagrams that each illustrate an example method of discovering and labeling speakers in a new audio stream in accordance with various embodiments

FIG. 3 is a diagram illustrating an example process that may be used to perform speaker segmentation in accordance with various embodiments.

FIG. 4 is a process flow diagram illustrating an example method of comparing and propagating labels in accordance with various embodiments.

FIG. 5 is a process flow diagram illustrating an example method of propagating user-assigned speaker labels where a user has labeled at least one speaker segment of a digital file in a set of digital files in accordance with various embodiments.

FIG. 6 is a process flow diagram illustrating an example method of merging or associating speaker models as shown after user-assigned speaker labels have been propagated as shown in FIG. 5 in accordance with various embodiments.

FIG. 7 is a diagrammatic representation of an example network device in which various embodiments may be implemented.

### DESCRIPTION OF EXAMPLE EMBODIMENTS

In the following description, numerous specific details are set forth in order to provide a thorough understanding of the disclosed embodiments. It will be obvious, however, to one skilled in the art, that the disclosed embodiments may be practiced without some or all of these specific details. In other instances, well-known process steps have not been described in detail in order to simplify the description.

### OVERVIEW

In one embodiment, an audio stream is partitioned into a plurality of segments such that the plurality of segments are clustered into one or more clusters, each of the one or more clusters identifying a subset of the plurality of segments in the audio stream and corresponding to one of a first set of one or more speaker models, each speaker model in the first set of one or more speaker models representing one of a first set of hypothetical speakers. The speaker models in the first set of one or more speaker models are compared with a second set of one or more speaker models, where each speaker model in the second set of one or more speaker models represents one of a second set of hypothetical speakers. Labels associated with one or more speaker models in the second set of one or more speaker models are propagated to one or more speaker models in the first set of one or more speaker models according to a result of the comparing step.

### SPECIFIC EXAMPLE EMBODIMENTS

Crowdsourcing is the act of sourcing tasks traditionally performed by specific individuals to a group of people or community (crowd). Crowdsourcing is desirable in some situations since it gathers those who are most fit to perform tasks and solve problems. However, crowdsourcing has not previously been applied to the problem of labeling speakers in audio streams (e.g., digital files storing audio streams).

The disclosed embodiments apply the concept of crowd-sourcing in combination with speaker segmentation and speaker clustering to audio streams (e.g., digital files) in order to efficiently and accurately propagate user-assigned labels (e.g., speaker names), labeling speakers of speaker segments such that those same labels are associated with those same speakers in other speaker segments in the same or other audio streams (e.g., digital files).

In accordance with various embodiments, audio streams may be made available to users via a network such a private network or the Internet. A user may assign a label to a segment of one of the audio streams in order to label the segment with a name of the speaker speaking in that segment. Through application of the disclosed embodiments, the system may effectively propagate the label to other segments of the audio streams in which that same speaker speaks.

The term “audio stream” is used herein to refer to a sequence of audio information, which can be accessed in sequential order. An audio stream may take the form of streaming audio that is constantly received by and presented to an end-user while being delivered by a streaming provider. Alternatively, an audio stream may be stored in the form of a digital file. Thus, each one of a plurality of digital files may include an audio stream.

The disclosed embodiments may also be applied to videos that include both video data (e.g., visual images) and audio streams. For example, one or more of the plurality of digital files may store a video that includes video data (e.g., visual images) and an audio stream.

In the following description, various embodiments are described with reference to audio streams. However, it is important to note that any audio stream may be implemented in the form of a video that includes visual images in addition to the audio stream.

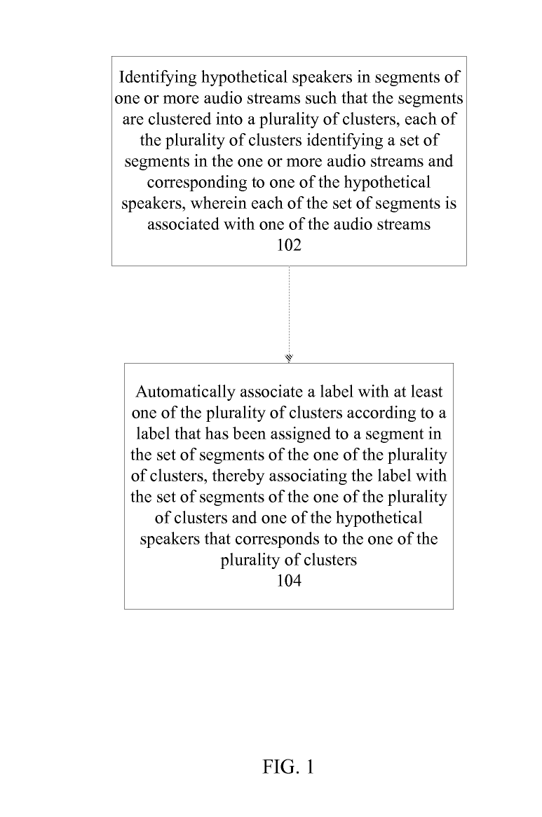

Before the system is described in detail, a general system overview will be provided. FIG. 1 is a process flow diagram illustrating an example method of implementing a system for discovering and labeling hypothetical speakers in accordance with various embodiments. As shown at 102, the system may identify hypothetical speakers in segments of a set of one or more audio streams such that the segments are clustered into a plurality of clusters, where each of the plurality of clusters identifies a set of segments in the set of audio streams and corresponds to one of the hypothetical speakers, wherein each segment in the set of segments is associated with an audio stream in the set of audio streams. The system may automatically associate a label at 104 with at least one of the plurality of clusters based upon a label that has been assigned (e.g., by a user) to a segment in the set of segments of the one of the plurality of clusters. In this manner, the label may be associated with the set of segments of the one of the plurality of clusters and the one of the hypothetical speakers that corresponds to the one of the plurality of clusters. As will be described in further detail below, a label may be associated with at least one cluster (and the corresponding segments) by associating the label with a corresponding speaker model.

A user may submit a query identifying a speaker (e.g., label identifying the speaker), where the speaker is one of the hypothetical speakers. The system may identify one of the plurality of clusters of segments having associated therewith a label identifying the speaker. The system may then return search results identifying the audio streams that include the set of segments of the identified one of the plurality of clusters. In this manner, propagation of labels may enable users to search for speakers across numerous audio streams.

In response to selection of an audio stream in the set of audio streams, the system may provide the audio stream such that labels (e.g., speaker names) for segments in the audio stream are presented. For example, the labels may be color-coded such that the speakers of the audio stream are differentiated by different colored segments. Since the labels may include a label identifying the speaker queried by the user, the labels that are presented may enable the user to navigate within the audio stream. Therefore, the user may select a particular segment of the audio stream in order to play and listen to the selected segment. For example, the user may wish to listen only to those segments of the audio stream having a label identifying the speaker queried by the user. Accordingly, a user may search audio streams using speaker metadata such as that identifying a name of the speaker.

In accordance with various embodiments, a user query may include one or more keywords in addition to the speaker name. For example, the keywords may identify subject matter of interest to the user or other metadata pertinent to the user query (e.g., year in which the speaker last spoke). The system may therefore identify or otherwise limit search results to the audio streams (and/or segments thereof) that are pertinent to the additional keywords. Therefore, the disclosed embodiments enable a user to effectively search for audio streams (or segments thereof) that include a particular speaker and are also pertinent to one or more keywords submitted by the user. Accordingly, a user may search audio streams using speaker metadata, as well as other metadata pertinent to the user query.

In the following description, labeling of audio streams will be described in two different sections. The first section includes a discussion of the propagation of labels to new audio streams. A new audio stream may be an audio stream that has not yet been processed by the system. The second section includes a discussion of the propagation of labels to audio streams that have already been processed by the system (e.g., where a user has provided a speaker label after the pertinent audio streams have been processed).

### Propagation of Labels to New Audio Streams

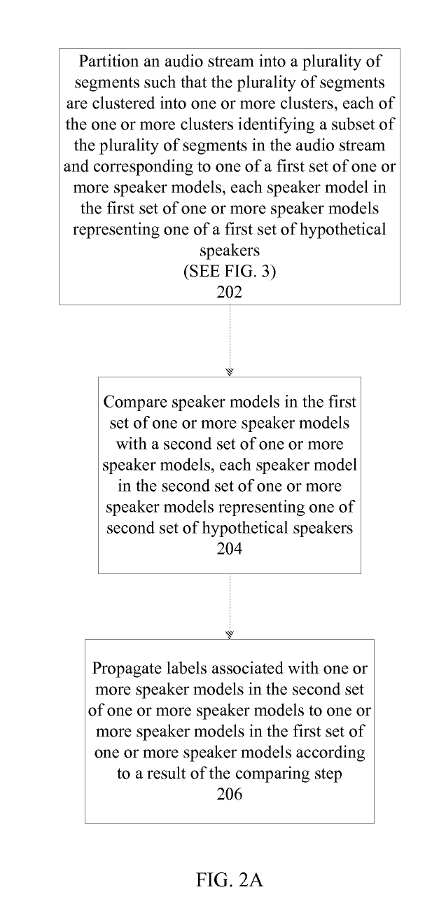

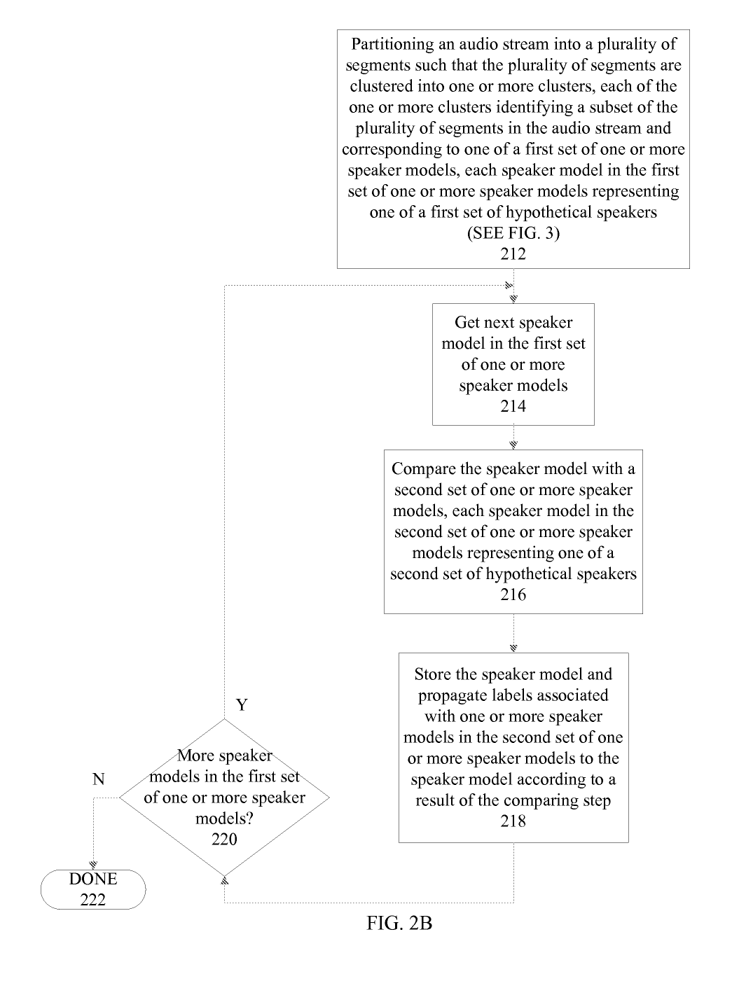

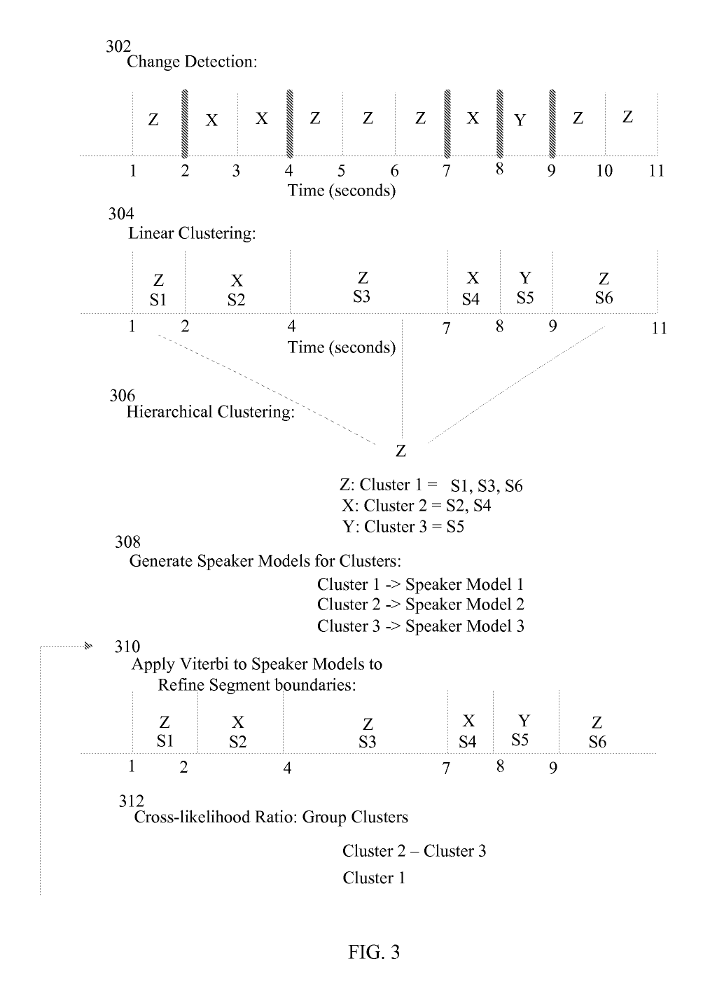

FIGS. 2A-2B are process flow diagrams that each illustrate an example method of discovering and labeling speakers for a new audio stream in accordance with various embodiments. As shown in FIG. 2A, when a new audio stream is processed (e.g., received and/or stored), the system may partition the audio stream into a plurality of segments at 202 such that the plurality of segments are clustered into one or more clusters, where each of the clusters identifies a subset of the plurality of segments in the audio stream and corresponds to one of a first set of one or more speaker models, and where each speaker model in the first set of speaker models represents one of a first set of hypothetical speakers. More particularly, a speaker model may be generated for each of the clusters based upon features of segments in that cluster. An example of speaker segmentation will be shown and described in further detail below with reference to FIG. 3.

Once speaker segmentation has been performed for the new audio stream, the system may compare speaker models in the first set of speaker models (e.g., associated with the new audio stream) with a second set of one or more speaker models (e.g., associated with previously processed audio streams) at 204, where each speaker model in the second set of speaker models represents one of a second set of hypothetical speakers. More particularly, each of the speaker models in the second set of speaker models may be associated with a set of one or more clusters, where each cluster in the set of clusters identifies a subset of a second plurality of segments. The second plurality of segments corresponds to one or more audio streams and may include the segments of all previously processed audio streams. It is important to note that a cluster in the set of clusters may identify segments from more than one audio stream. In other words, a cluster and corresponding speaker model in the second set of speaker models may correspond to segments from multiple audio streams.

In accordance with various embodiments, the second set of speaker models may be stored in a database. Each speaker model may be linked or otherwise associated with one or more clusters. Furthermore, each of the clusters may be linked or otherwise associated with one or more segments of one or more audio streams. Speaker models may also be linked to one another. Such linking and associations may be accomplished via a variety of data structures including, but not limited to, data objects and linked lists.

The system may propagate labels associated with one or more speaker models in the second set of speaker models to one or more speaker models in the first set of speaker models according to a result of the comparing step at 206. More particularly, those speaker models in the first set that fall below a particular threshold (according to similarity of label and/or based upon feature values) may simply be stored without propagation of labels. Labels may be propagated from speaker models in the second set to speaker models in the first set that are deemed to meet or exceed a particular threshold. More particularly, speaker models in the first set may be stored in the second set of speaker models and associated with the pertinent speaker models in the second set of speaker models, thereby implicitly propagating labels to the newly processed audio stream. In addition, labels may be directly associated with the appropriate speaker models in the first set (e.g., by storing the label(s) in the pertinent data structure(s)). In some embodiments, a composite representation may be generated from select speaker models including one or more speaker models in the first set and one or more speaker models in the second set. More particularly, a composite representation may be generated by merging two or more speaker models (e.g., one of the speaker models in the first set and one or more speaker models in the second set). Merging of two or more models may be accomplished by optimizing cross likelihood ratio (CLR) or another suitable criterion. Alternatively, a composite representation may be generated by combining at least a portion of the data representing each of the two or more speaker models. In this manner, the first set of speaker models corresponding to the first set of hypothetical speakers may be integrated into the second set of speaker models corresponding to the second set of hypothetical speakers.

A user may then search for a particular speaker across multiple audio streams such as digital files, as well as successfully navigate among speaker segments within a single digital file. More particularly, the user may submit a search query identifying a speaker (e.g., label identifying the speaker), where the speaker is one of the speakers in the second set of hypothetical speakers. The system may identify the speaker model representing the identified speaker and the set of clusters corresponding to that speaker model by identifying the speaker model having associated therewith a label identifying the speaker (e.g., the label submitted by the user). The system may then return search results identifying the audio streams that include the segments in the set of clusters.

In response to a selection of one of the search results, the system may further provide the corresponding audio stream such that labels for segments in the audio stream are presented. Since the labels may identify speakers, the labels may assist a user in navigating within the audio stream. More particularly, the system may present the labels via a graphical user interface, enabling users to select and listen to selected segment(s) within an audio stream using the labels presented.

FIG. 2B is a process flow diagram illustrating a process of propagating labels to speaker models in further detail. The system may partition an audio stream into a plurality of segments at 212 such that the plurality of segments are clustered into one or more clusters, where each of the clusters identifies a subset of the plurality of segments in the audio stream and corresponds to one of a first set of one or more speaker models, where each speaker model in the first set of speaker models represents one of a first set of hypothetical speakers. An example of speaker segmentation will be shown and described in further detail below with reference to FIG. 3.

Each of the speaker models in the first set of speaker models may be processed as follows. The next speaker model in the first set of speaker models may be obtained at 214. The system may compare the speaker model with a second set of one or more speaker models at 216, where each speaker model in the second set of speaker models represents one of a second set of hypothetical speakers. More particularly, each of the speaker models in the second set of speaker models may be associated with a set of one or more clusters, where each cluster in the set of clusters may identify a subset of a second plurality of segments, where the second plurality of segments corresponds to one or more audio streams (e.g., all previously processed audio streams). The system may store the speaker model and propagate labels associated with one or more speaker models in the second set of speaker models to the speaker model according to a result of the comparing step at 218. More particularly, the system may associate the speaker model with one or more speaker models in the second set of speaker models and/or generate a composite representation from the speaker model and the one or more speaker models in the second set of speaker models. If the system determines that there are more speaker models in the first set that remain to be processed at 220, the system continues at 214. The process completes at 222 for the audio stream when no further speaker models in the first set remain to be processed. The system may repeat the method shown in FIG. 2B for each additional audio stream that is processed.

FIG. 3 is a diagram illustrating a simplified example of a process that may be used to perform speaker segmentation of an audio stream to identify speakers in segments of the audio stream and cluster those segments according to speaker as described above at 202 and 212 of FIGS. 2A and 2B, respectively. An audio stream may be divided into a plurality of segments. In this example, the audio stream is divided into a plurality of segments having the same size based upon a time period such as one second. In order to further illustrate the speaker segmentation process in this example, segments are labeled with X, Y, or Z to identify those segments that are acoustically similar. For purposes of this example, those segments that are acoustically similar are referred to as including the same hypothetical speaker, Speaker X, Y, or Z. It is important to note that although segments that are acoustically similar may include the same speaker, they need not include the same speaker.

The system may extract a plurality of feature vectors for each of the segments. The system may further generate a statistical model for each of the segments based upon the extracted feature vectors. As shown at 302, the system may perform change detection based upon the statistical models by optimizing BIC or other suitable criterion in order to detect boundaries between segments. More particularly, the system may check neighboring segment pairs for a change in BIC or other suitable criterion, and mark segment boundaries at which such change is detected. In this example, a change is detected at the following segment boundaries: 2 seconds, 4 seconds, 7 seconds, 8 seconds, and 9 seconds, denoted by thickened vertical lines.

The system may then perform linear clustering, as shown at 304. More particularly, the system may treat the consecutive segments between two boundaries at which a change is detected as a single segment. For example, the segments between segment boundaries at 2 seconds and 4 seconds may be merged into a single segment, S2, corresponding to speaker X. Segments between segment boundaries at 4 seconds and 7 seconds may be merged into a single segment, S3, corresponding to speaker Z. Similarly, segments between segment boundaries at 9 seconds and 11 seconds may be merged into a single segment, S6, corresponding to speaker Z. Therefore, linear clustering generates new segments S1-S6.

The system may perform hierarchical clustering as shown at 306. More particularly, the system may extract a plurality of feature vectors for each of the newly generated segments. In addition, the system may generate a statistical model for each of the segments based upon the extracted feature vectors. In hierarchical clustering, the system compares each segment in the audio stream with every other segment in the audio stream (e.g., by comparing statistical models). The system generates clusters such that each cluster identifies segments of the audio stream that the system has determined includes the same hypothetical speaker. At the completion of hierarchical clustering, each of the segments in the audio stream has been grouped into one of the clusters (e.g., based upon similarity between the statistical models).

In this example, segments S1, S3, and S6 are grouped into Cluster 1, since the statistical models representing these segments are found to be similar. Cluster 1 represents the hypothetical speaker Z. Similarly, Cluster 2 represents hypothetical speaker X, and includes segments S2 and S4. Cluster 3 represents hypothetical speaker Y, and includes segment S5.

The system may generate a speaker model for each of the clusters at 308. More particularly, the speaker model may be a statistical model that is generated based upon the feature vectors of a set of segments in a cluster. For example, a Gaussian Mixture Model (GMM) may be generated for each cluster based upon the feature vectors of each of the segments in the corresponding cluster. As shown in this example, Speaker Model 1 corresponds to Cluster 1, Speaker Model 2 corresponds to Cluster 2, and Speaker Model 3 corresponds to Cluster 3.

The system may then apply the Viterbi algorithm at 310 to the Speaker Models to refine the segmentation boundaries using all of the feature vectors obtained for the audio stream. As shown in this example, although the segments may remain substantially the same, the boundaries of the segments may be modified as a result of the refinement of the segmentation boundaries.

The system may then group the clusters at 312, as appropriate. More particularly, CLR or other suitable criterion may be optimized to compare segments of a cluster with segments of other clusters. Clusters that are “similar” based upon the features of the corresponding segments may be grouped accordingly. In addition, the speaker models of these clusters may also be associated with one another, and/or a composite representation may be generated from the speaker models. In this example, clusters 2 and 3 are grouped together. The corresponding speaker models, Speaker Model 2 and Speaker Model 3, may also be associated with one another and/or used to generate a composite representation. In this manner, two or more clusters and corresponding speaker models associated with the same speaker may be associated with one another and/or used to generate a composite representation.

The system may continue to apply Viterbi and optimize CLR or other suitable criterion at 310 and 312, respectively, until the system determines that the clusters are different enough that they cannot include the same speaker. Through the use of speaker segmentation, the system may easily identify a hypothetical speaker for each segment of an audio stream. However, it is important to note that although the system has ascertained that the same speaker is speaking in various segments of the audio stream, the system may not be able to label (e.g., name) the hypothetical speaker as a result of speaker segmentation.

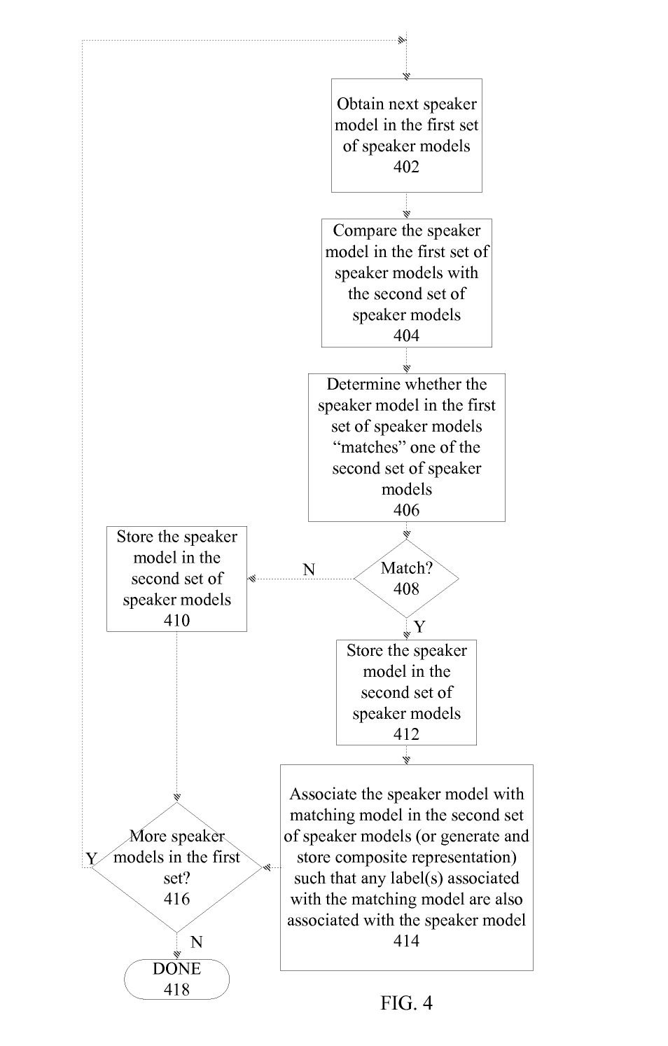

In accordance with various embodiments, crowd-sourcing of speaker labels may be advantageously leveraged in order to efficiently and accurately label speakers in newly processed audio streams. FIG. 4 is a process flow diagram illustrating an example method of comparing and propagating labels in accordance with various embodiments, as described above with reference to 204-206 and 214-222 of FIGS. 2A and 2B, respectively. After speaker segmentation has been performed on an audio stream, the speaker segmentation process may produce a first set of one or more speaker models. The system may obtain a next speaker model in the first set of speaker models at 402. The system may compare the speaker model in the first set of speaker models with the second set of speaker models (e.g., associated with previously processed audio streams) at 404. The system may determine whether the speaker model in the first set of speaker models “matches” one of the second set of speaker models at 406. More particularly, the system may compare the speaker models using a dot product between mean super vectors or by using CLR.

If the speaker model in the first set of speaker models does not match any of the speaker models in the second set as shown at 408, the system may store the speaker model such that it is added to the second set of speaker models at 410. However, if the speaker model is found to match one of the speaker models in the second set of speaker models at 408, the speaker model may be stored in the second set of speaker models at 412 and associated with and/or used to generate and store a composite representation with the matching model in the second set of speaker models at 414 such that any label(s) associated with the matching speaker model are also implicitly associated with the speaker model. For example, the label(s) may be associated with the speaker model by simply linking to the pertinent data structure. Furthermore, any label(s) associated with the matching speaker model may also be stored in association with the speaker model (e.g., in a data structure storing information pertaining to the speaker model). The process may continue at 416 for all remaining speaker models in the first set until the process completes at 418.

As described above, one or more speaker models in the first set may be associated with and/or used to generate a composite representation with one or more speaker models in the second set. In accordance with one embodiment, speaker models are merely associated with one another rather than used to generate a composite representation (e.g., merged) until confirmation of the propagation of labels is obtained. Therefore, generation of a composite representation from (e.g., merging) two or more speaker models may be performed after confirmation of accurate propagation of labels is obtained from a user.

### Propagation of Newly Assigned Labels to Previously Processed Audio Streams

As described above, each of the speaker models in the second set of speaker models (e.g., speaker model database) may be associated with a set of one or more clusters, where each cluster in the set of clusters may identify a subset of a second plurality of segments, where the second plurality of segments corresponds to one or more audio streams (e.g., all previously processed audio streams). Stated another way, the segments of all previously processed audio streams may be referred to collectively as the second plurality of segments. Therefore, each cluster in the set of clusters may correspond to segments from more than one audio stream.

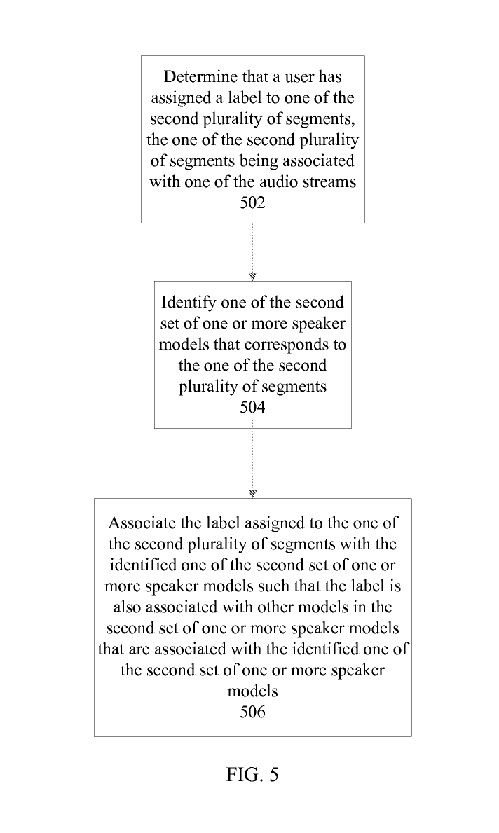

FIG. 5 is a process flow diagram illustrating an example method of propagating user-assigned speaker labels where a user has labeled at least one speaker segment of a single digital file in a set of digital files in accordance with various embodiments. The system may determine that a user has assigned a label to one of the second plurality of segments at 502, the one of the second plurality of segments being associated with one of the one or more audio streams. The system may identify one of the second set of speaker models that corresponds to the one of the second plurality of segments at 504. The system may associate the label assigned to the one of the second plurality of segments with the identified one of the second set of speaker models at 506. More particularly, the label may be associated (e.g., implicitly or explicitly) with the speaker model in the second set of speaker models such that the label is also associated with other models in the second set of speaker models that are associated with the identified one of the second set of speaker models. Accordingly, labels that have been assigned by users to various segments of audio streams may be propagated to the pertinent speaker models.

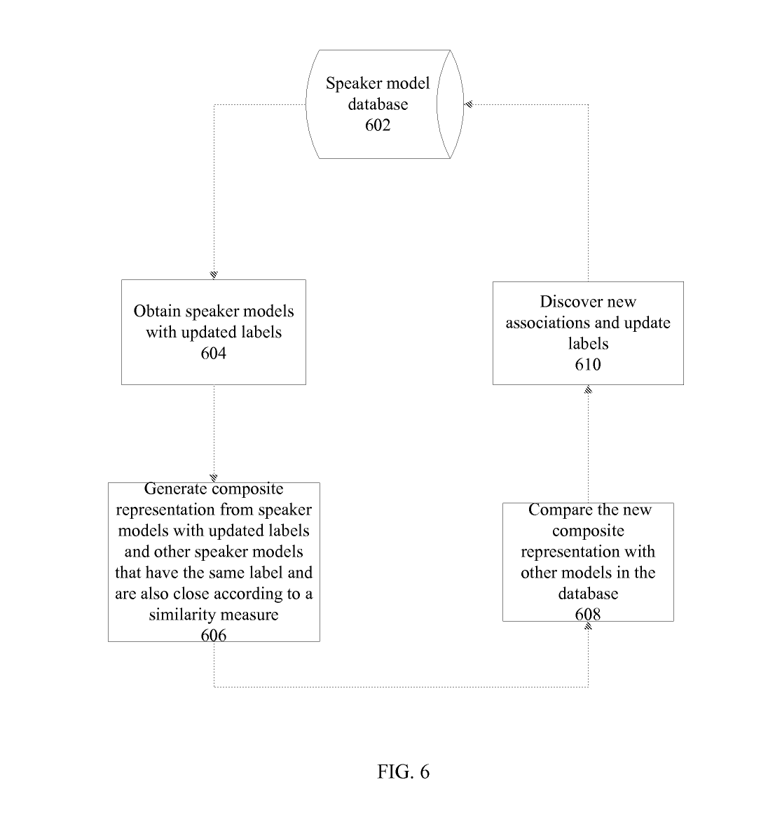

Speaker models in the second set of speaker models may then be associated with one another and/or used to generate a composite representation, as appropriate. FIG. 6 is a process flow diagram illustrating an example method of generating a composite representation or associating speaker models after user-assigned speaker labels have been propagated as described above with reference to FIG. 5 in accordance with various embodiments. As shown in this example, a second set of speaker models may be stored in a speaker model database. In this database, one or more of the speaker models may be stored in association with a corresponding label (e.g., speaker name). The system may identify speaker models in the second set of speaker models that have updated labels at 604. These identified speaker models may be compared with other speaker models in the second set of speaker models (e.g., with all other speaker models or those that are associated with the identified speaker models). Each of the identified speaker models and other speaker models in the second set that have the same label and/or are close according to a similarity measure may be associated with one another and/or used to generate a composite representation at 606. More particularly, upon determining that a first speaker model in the second set of one or more speaker models and a second speaker model in the second set of one or more speaker models 1) have the same label and 2) are close according to a similarity measure, the system may generate a composite representation (e.g., a merged model) from the first speaker model and the second speaker model such that a composite representation is generated. The new composite representation may then be compared with other speaker models in the second set of speaker models (e.g., database) at 608.

The system may then discover new associations between the composite representation and other speaker models in the database and update labels of the pertinent speaker models at 610, as appropriate. More particularly, the system may compare the composite representation with other speaker models in the second set of speaker models. The system may associate the composite representation with one or more other speaker models in the second set of speaker models (or generate a further composite representation from the composite representation and the one or more other speaker models in the second set of speaker models) such that labels of one or more of the other speaker models in the second set of one or more speaker models are updated according to a result of the comparing step. In accordance with various embodiments, the composite representation and other speaker models in the second set that have the same label and/or are close according to a similarity measure may be associated with one another and/or used to generate a further composite representation (having the same label). For example, upon determining that the composite representation and a second speaker model in the second set of one or more speaker models have the same label and are close according to a similarity measure, the system may generate another composite representation from the composite representation and the second speaker model (e.g., such that another merged model having the same label is generated).

In accordance with various embodiments, speaker models are merely associated with one another rather than used to generate a composite representation (e.g., merged) until confirmation of the propagation of labels is obtained. Therefore, generation of a composite representation from two or more speaker models may be delayed until confirmation of accurate propagation of labels is obtained from a user. Confirmation of an accurate label associated with a particular model (and therefore corresponding segments) may be obtained via proactively providing a question to be answered by a user in association with at least one of the segments.

In accordance with various embodiments, in response to a user query for a particular speaker, the system may suggest that it has found an audio stream (or segment) that identifies a particular queried speaker. The user may then submit feedback to the system indicating whether the user agrees that the audio stream (or segment) does, in fact, include the queried speaker.

Based upon user feedback, the system may correct labels associated with specific segments, segment clusters and/or associated speaker models. More particularly, the system may “unlabel” a segment or segment cluster (e.g., associated speaker model) or replace a previous label (of a segment, segment cluster, or associated speaker model) with another (e.g., user-submitted) label. Furthermore, the system may correct any errors in the association of models or generation of composite representations based upon user feedback. For example, when a user labels a segment of an audio stream that is inconsistent with the label that has already been assigned by the system to the corresponding speaker model, the system may exclude this segment in further computations. Alternatively, the system may re-label the corresponding speaker model with the label submitted by the user and re-compute the pertinent speaker models and/or associations. Accordingly, crowd-sourcing may be applied to correct incorrectly assigned labels, regardless of whether the incorrectly assigned labels have been user-assigned or propagated via the system.

Generally, the techniques for performing the disclosed embodiments may be implemented on software and/or hardware. For example, they can be implemented in an operating system kernel, in a separate user process, in a library package bound into network applications, on a specially constructed machine, or on a network interface card. In a specific embodiment, software and/or hardware may be configured to operate in a client-server system running across multiple network devices. More particularly, speaker labels may be updated via a central server operating according to the disclosed embodiments. In addition, a software or software/hardware hybrid system of the disclosed embodiments may be implemented on a general-purpose programmable machine selectively activated or reconfigured by a computer program stored in memory. Such programmable machine may be a network device designed to handle traffic. Such network devices typically have multiple network interfaces. Specific examples of such network devices include routers and switches.

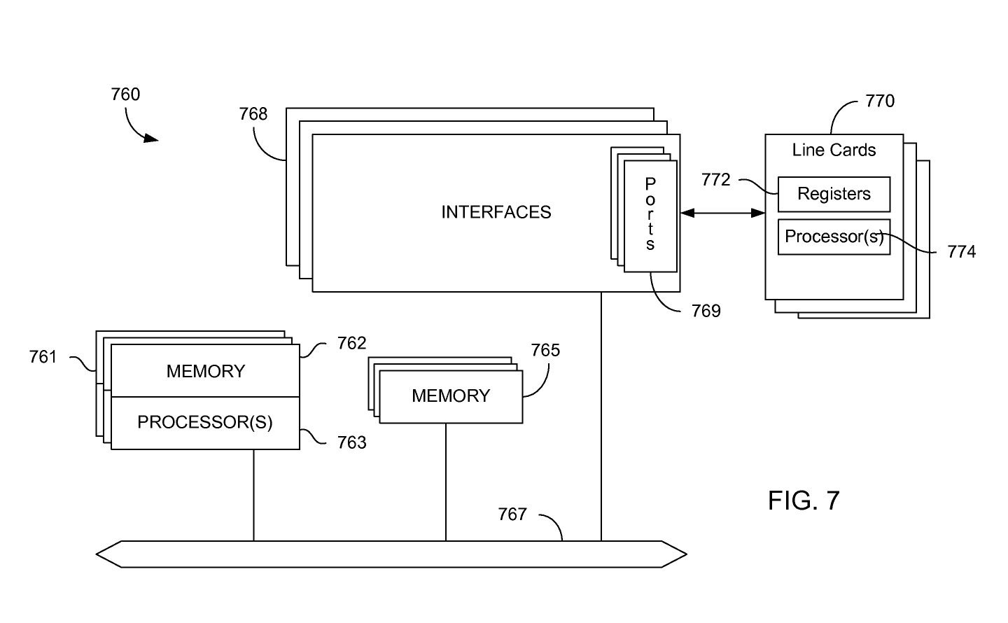

FIG. 7 illustrates an example of a network device that may be configured to implement some methods of the present invention. Network device 760 includes a master central processing unit (CPU) 761, interfaces 768, and a bus 767 (e.g., a PCI bus). Generally, interfaces 768 include ports 769 appropriate for communication with the appropriate media. In some embodiments, one or more of interfaces 768 includes at least one independent processor 774 and, in some instances, volatile RAM. Independent processors 774 may be, for example ASICs or any other appropriate processors. According to some such embodiments, these independent processors 774perform at least some of the functions of the logic described herein. In some embodiments, one or more of interfaces 768 control such communications-intensive tasks as media control and management. By providing separate processors for the communications-intensive tasks, interfaces 768 allow the master microprocessor 763 efficiently to perform other functions such as routing computations, network diagnostics, security functions, etc.

The interfaces 768 are typically provided as interface cards 770 (sometimes referred to as “line cards”). Generally, interfaces 768 control the sending and receiving of data packets over the network and sometimes support other peripherals used with the network device 760. Among the interfaces that may be provided are Fibre Channel (“FC”) interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 761 may be responsible for implementing specific functions associated with the functions of a desired network device. According to some embodiments, CPU 761 accomplishes all these functions under the control of software including an operating system (e.g. Linux, VxWorks, etc.), and any appropriate applications software.

CPU 761 may include one or more processors 763 such as a processor from the Motorola family of microprocessors or the MIPS family of microprocessors. In an alternative embodiment, processor 763 is specially designed hardware for controlling the operations of network device 760. In a specific embodiment, a memory 762 (such as non-volatile RAM and/or ROM) also forms part of CPU 761. However, there are many different ways in which memory could be coupled to the system. Memory block 762 may be used for a variety of purposes such as, for example, caching and/or storing data, programming instructions, etc.

Regardless of network device's configuration, it may employ one or more memories or memory modules (such as, for example, memory block 765) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher level code that may be executed by the computer using an interpreter.

Although the system shown in FIG. 7 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces/line cards may be bus based (as shown in FIG. 7) or switch fabric based (such as a cross-bar).

Regardless of network device's configuration, it may employ one or more memories or memory modules configured to store data, program instructions for the general-purpose network operations and/or the inventive techniques described herein. The program instructions may control the operation of an operating system and/or one or more applications, for example.

Although illustrative embodiments and applications of the disclosed embodiments are shown and described herein, many variations and modifications are possible which remain within the concept, scope, and spirit of the disclosed embodiments, and these variations would become clear to those of ordinary skill in the art after perusal of this application. Moreover, the disclosed embodiments need not be performed using the steps described above. Accordingly, the present embodiments are to be considered as illustrative and not restrictive, and the disclosed embodiments are not to be limited to the details given herein, but may be modified within the scope and equivalents of the appended claims.

What is claimed is:

1. A method, comprising:
partitioning by a network device an audio stream into a plurality of segments such that the plurality of segments are clustered into one or more clusters, each of the one or more clusters identifying a subset of the plurality of segments in the audio stream and corresponding to one of a first set of one or more speaker models, each speaker model in the first set of one or more speaker models representing one of a first set of hypothetical speakers;
comparing by the network device speaker models in the first set of one or more speaker models with a second set of one or more speaker models, each speaker model in the second set of one or more speaker models representing one of a second set of hypothetical speakers; and
propagating by the network device labels associated with one or more speaker models in the second set of one or more speaker models to one or more speaker models in the first set of one or more speaker models according to a result of the comparing step.

2. The method as recited in claim 1, wherein each of the one or more speaker models in the second set of one or more speaker models is associated with a set of one or more clusters, each of the set of one or more clusters identifying a subset of a second plurality of segments, the second plurality of segments corresponding to one or more audio streams.

3. The method as recited in claim 2, wherein each of the labels has been originated by a corresponding user in association with one or more segments of one or more of the one or more audio streams.

4. The method as recited in claim 2, further comprising:
receiving a search query identifying a speaker ; and
returning search results identifying a subset of the one or more audio streams that include the subset of the second plurality of segments for each of the set of one or more clusters associated with one of the second set of one or more speaker models, the one of the second set of one or more speaker models representing the one of the second set of hypothetical speakers and having a label identifying the speaker.

5. The method as recited in claim 4, further comprising:
providing an audio stream in the subset of the one or more audio streams such that labels for segments in the audio stream are presented, wherein the labels include the label identifying the speaker.

6. The method as recited in claim 1, wherein a video comprises the audio stream.

7. The method as recited in claim 1, further comprising:
generating each of the first set of one or more speaker models from feature values for a plurality of features of segments identified in a corresponding one of the one or more clusters.

8. The method as recited in claim 1, wherein propagating labels comprises:
associating one or more speaker models in the first set of one or more speaker models with one or more speaker models in the second set of one or more speaker models, or generating a composite representation from one or more speaker models in the first set of one or more speaker models and one or more speaker models in the second set of one or more speaker models.

9. The method as recited in claim 1, further comprising:
generating a composite representation from one or more speaker models in the first set of one or more speaker models and one or more speaker models in the second set of one or more speaker models in response to confirmation of accurate propagation of labels.

10. The method as recited in claim 1, further comprising:
storing at least one of the first set of one or more speaker models such that the at least one of the first set of one or more speaker models is added to the second set of one or more speaker models.

11. The method as recited in claim 2, further comprising:
determining that a user has assigned a label to one of the second plurality of segments, the one of the second plurality of segments being associated with one of the one or more audio streams;
identifying one of the second set of one or more speaker models that corresponds to the one of the second plurality of segments; and
associating the label assigned to the one of the second plurality of segments with the identified one of the second set of one or more speaker models.

12. The method as recited in claim 11, wherein associating is performed such that the label is also associated with other models in the second set of one or more speaker models that are associated with the identified one of the second set of one or more speaker models.

13. The method as recited in claim 1, further comprising
determining that a first speaker model in the second set of one or more speaker models and a second speaker model in the second set of one or more speaker models at least one of: 1) have the same label or 2) are close according to a similarity measure; and
generating a composite representation from the first speaker model and the second speaker model, the composite representation having the label of the first speaker model and the second speaker model.

14. The method as recited in claim 13, wherein generating a composite representation is performed in response to confirmation of accurate propagation of labels.

15. The method as recited in claim 13, further comprising:
comparing the composite representation with other speaker models in the second set of one or more speaker models; and
updating labels of one or more of the other speaker models in the second set of one or more speaker models with the label of the composite representation according to a result of the comparing step.

16. The method as recited in claim 13, further comprising:
comparing the composite representation with other speaker models in the second set of one or more speaker models; and
associating one or more of the other speaker models in the second set of one or more speaker models with the composite representation according to a result of the comparing step.

17. An apparatus, comprising:
a processor; and
a memory, at least one of the processor or the memory being adapted for:
partitioning an audio stream into a plurality of segments such that the plurality of segments are clustered into one or more clusters, each of the one or more clusters identifying a subset of the plurality of segments in the audio stream and corresponding to one of a first set of one or more speaker models, each speaker model in the first set of one or more speaker models representing one of a first set of hypothetical speakers; and
for each speaker model in the first set of one or more speaker models,
comparing the speaker model with a second set of one or more speaker models, each speaker model in the second set of one or more speaker models representing one of a second set of hypothetical speakers; and
propagating labels associated with one or more speaker models in the second set of one or more speaker models to the speaker model in the first set of one or more speaker models according to a result of the comparing step.

18. A method, comprising:
identifying by a network device hypothetical speakers in segments of one or more audio streams such that the segments are clustered into a plurality of clusters, each of the plurality of clusters identifying a set of segments in the one or more audio streams and corresponding to one of the hypothetical speakers, wherein each of the set of segments is associated with one of the audio streams; and
automatically associating by the network device a label with at least one of the plurality of clusters according to a label that has been assigned to a segment in the set of segments of the one of the plurality of clusters, thereby associating the label with the set of segments of the one of the plurality of clusters and the one of the hypothetical speakers that corresponds to the one of the plurality of clusters.

19. The method as recited in claim 18, wherein the label that has been assigned to the segment is user-assigned.

20. The method as recited in claim 18, further comprising:
receiving a search query identifying a speaker, the speaker being one of the hypothetical speakers;
identifying one of the plurality of clusters having associated therewith a label identifying the speaker; and
returning search results identifying a set of one or more audio streams that include the set of segments of the one of the plurality of clusters.

21. The method as recited in claim 20, further comprising:
receiving a selection of an audio stream in the set of audio streams; and
providing the audio stream in the set of audio streams such that labels for segments in the audio stream are presented, wherein the labels include the label identifying the speaker, thereby facilitating navigation within the audio stream.

22. The method as recited in claim 18, further comprising:
receiving a search query identifying a speaker and including one or more additional keywords, the speaker being one of the hypothetical speakers;
identifying one of the plurality of clusters having associated therewith a label identifying the speaker;
ascertaining a set of one or more audio streams that include the set of segments of the one of the plurality of clusters; and
returning search results identifying at least a portion of the set of one or more audio streams, the at least a portion of the set of one or more audio streams being pertinent to the one or more additional keywords.

23. The method as recited in claim 22, further comprising:
receiving a selection of one of the at least a portion of the set of one or more audio streams; and
identifying a subset of segments in the selected audio stream, wherein the subset of segments is pertinent to the one or more additional keywords.

24. The method as recited in claim 18, wherein each of one or more videos comprises a corresponding one of the one or more audio streams.

25. A non-transitory computer-readable medium storing thereon computer-readable instructions, comprising:
instructions for identifying hypothetical speakers in segments of one or more audio streams such that the segments are clustered into a plurality of clusters, each of the plurality of clusters identifying a set of segments in the one or more audio streams and corresponding to one of the hypothetical speakers, wherein each of the set of segments is associated with one of the audio streams; and
instructions for automatically associating a label with at least one of the plurality of clusters according to a label that has been assigned to a segment in the set of segments of the one of the plurality of clusters, thereby associating the label with the set of segments of the one of the plurality of clusters and the one of the hypothetical speakers that corresponds to the one of the plurality of clusters.

26. The non-transitory computer-readable medium storing thereon computer-readable instructions as recited in claim 25, wherein the label that has been assigned to the segment is user-assigned.

27. The non-transitory computer-readable medium storing thereon computer-readable instructions as recited in claim 25, further comprising:
instructions for correcting the label associated with one of the plurality of clusters or one of the set of segments of the one of the plurality of clusters in response to user input.

28. The non-transitory computer-readable medium as recited in claim 27, wherein the label is corrected by replacing the label with another label.

29. The non-transitory computer-readable medium as recited in claim 25, wherein each of one or more digital files comprises a corresponding one of the one or more audio streams.
